(19) United States
(12) Patent Application Publication
(10) Pub. No.: US 2014/0360438 A1
(43) Pub. Date: Dec. 11, 2014

(54) METHOD AND SYSTEM FOR RELEASE OF GAME ANIMALS

(71) Applicant: William Terrell Cooke, III, Amarillo, TX (US)

(72) Inventor: William Terrell Cooke, III, Amarillo, TX (US)

(21) Appl. No.: 14/297,916

(22) Filed: Jun. 6, 2014

Related U.S. Application Data
(60) Provisional application No. 61/831,917, filed on Jun. 6, 2013.

(51) Int. Cl. A01K 1/08; A01K 1/00

(52) U.S. Cl. CPC A01K 1/08; A01K 1/0035
USPC 119/427

(57) ABSTRACT

Described are an apparatus and method for remotely releasing one or more game animals. The apparatus includes one or more doors that enclose an inside of a game-release box. When in a closed position, the game-release box can selectively secure one or more game animals. The game-release box may include a receiver in communication with a remote, and may include an actuator that selectively engages one of the one or more doors. Upon receiving a signal from the remote, the receiver causes the actuator to disengage a latch associated with one of the one or more doors. Once at least one of the one or more doors has opened, the one or more game animals may exit the game-release box.

### CROSS-REFERENCE TO RELATED APPLICATIONS

This application claims priority to, and incorporates by reference the entire disclosure of, U.S. Provisional Patent Application No. 61/831,917 filed on Jun. 6, 2013.

### BACKGROUND

1. Field of the Invention

The present invention relates generally to the field of hunting aids, and more particularly, but not by way of limitation, to a method and apparatus for remotely releasing animals.

2. History of the Related Art

Hunting is a popular pastime. Due to its popularity, many businesses have been established to cater to the needs and wants of hunters. One such business is that of hunting guides. Often times a hunter does not have the knowledge, experience, time, etc. to arrange a hunting trip on his or her own. In such instances, a hunter can hire a guide to arrange some or all of the hunting trip. A hunting guide needs many skills to be successful. For example, knowledge of the area where the hunting will take place and of the game that is being hunted is important. However, even the most knowledgeable guide cannot always guarantee that his hunter-clients will be presented with the opportunity to engage a sought-after game animal. Therefore, it would be advantageous to provide a guide or a hunter with the ability to control when and where an opportunity to engage the sought-after game animal is to occur.

### SUMMARY

The present invention relates generally to hunting aids and more particularly, but not by way of limitation, to game-release boxes having a remotely operated door to release one or more game animals as desired. The game-release box includes a frame including at least four sides, the four sides defining a space within the frame; a first door pivotally attached to a first bottom edge of one of the at least four sides of the frame, the first door including a latch; an actuator attached to the frame and positioned to selectively engage the latch; a receiver attached to the game-release box, the receiver operatively coupled to the actuator; wherein the actuator disengages from the latch in response to a signal sent to the receiver from a remote; and wherein the first door opens after the actuator disengages the latch.

According to a second a second aspect, the present invention relates to a game-release box including a bottom surface; a first door attached to a first edge of the bottom surface, the first door including a first tab on a first edge of the first door; a second door adjacent to the first door and attached to a second edge of the bottom surface; wherein the first tab overlaps a portion of the second door when the first door and the second door are in the closed position; and wherein opening the first door allows the second door to open.

In another aspect, the present invention relates to a method of remotely controlling a release of one or more game animals including the steps of inserting one or more game animals into a game-release box; placing the game-release box in a selected area; sending a signal from a remote to a receiver; and responsive to receiving the signal, opening a door of the game-release.

### BRIEF DESCRIPTION OF THE DRAWINGS

For a more complete understanding of the present invention and for further objects and advantages thereof, reference may now be had to the following description taken in conjunction with the accompanying drawings in which:

FIG. 1A is an isometric view of a game-release box in a closed position according to an exemplary embodiment;

FIG. 1B is an isometric view of a game-release box in an opened position according to an exemplary embodiment;

FIG. 2 is an exploded assembly of a game-release box according to an exemplary embodiment;

FIG. 3 is an isometric view of a game-release box with a water source and a food source attached, and a loading tube inserted according to an exemplary embodiment;

FIG. 4 is an isometric view of a game-release box in an opened position according to an exemplary embodiment;

FIG. 5 is a flow diagram of a method of using the game-release box according to an exemplary embodiment; and

FIG. 6 depicts a user using an embodiment of a game-release box according to an exemplary embodiment.

### DETAILED DESCRIPTION

Various embodiments of the present invention will now be described more fully with reference to the accompanying drawings. The invention may, however, be embodied in many different forms and should not be construed as limited to the embodiments set forth herein.

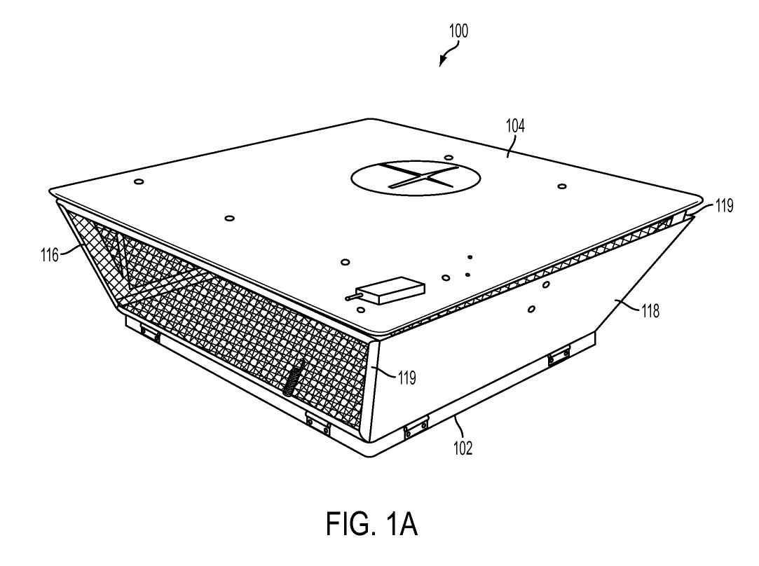

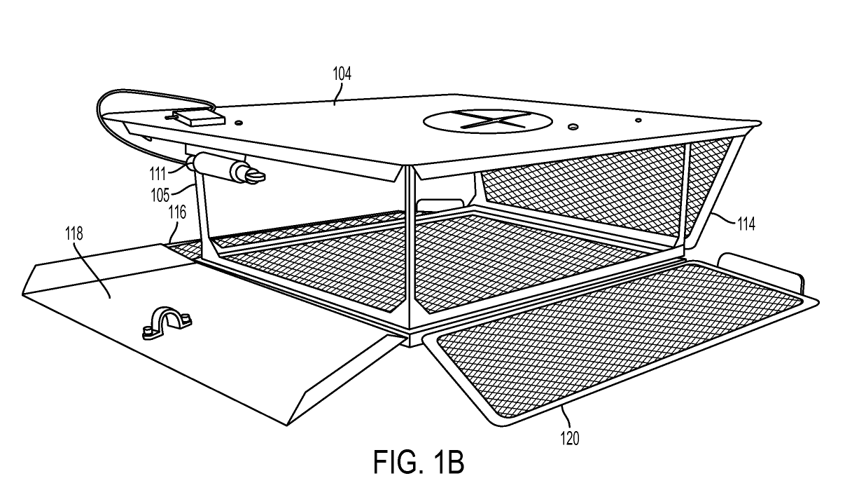

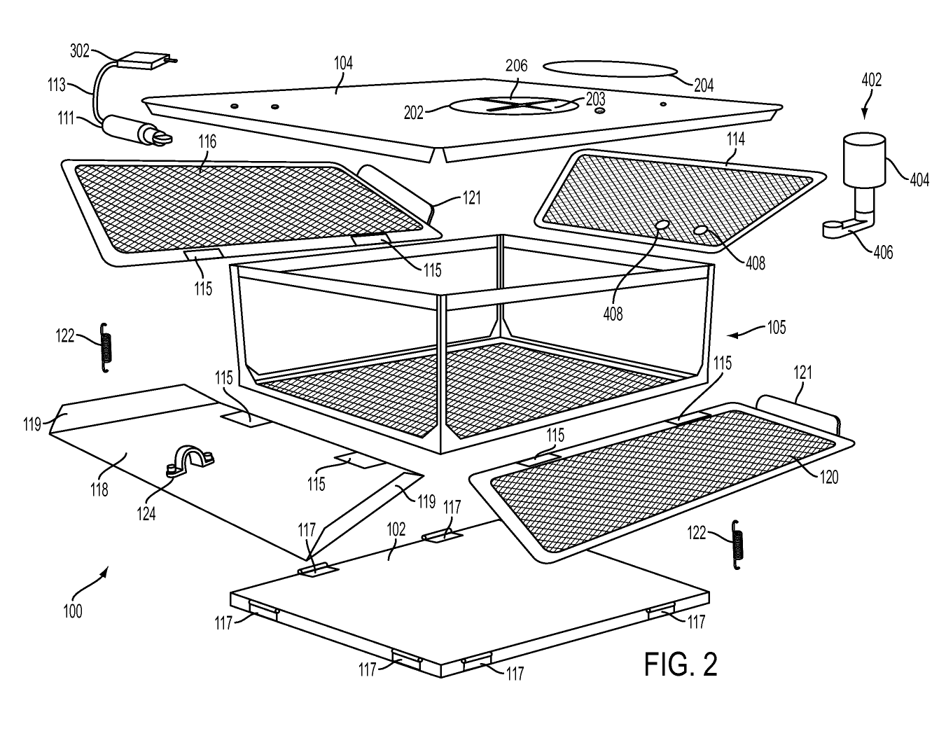

FIGS. 1A and 1B are isometric views of a game-release box 100 in a closed and an opened position, respectively, according to an exemplary embodiment. The game-release box 100 includes a bottom surface 102, a top surface 104, and a frame 105. The bottom surface 102 is secured to a bottom portion of the frame 105, and the top surface 104 is secured to a top portion of the frame 105 (best seen in FIG. 2). The game-release box 100 further includes a side door 116, a main door 118, a side door 120, and a fixed wall 114. In the closed position, the side door 116, the main door 118, and the side door 120 are each in the positions shown in FIG. 1A. In the opened position, the side door 116, the main door 118, and the side door 120 are each in the positions shown in FIG. 1B.

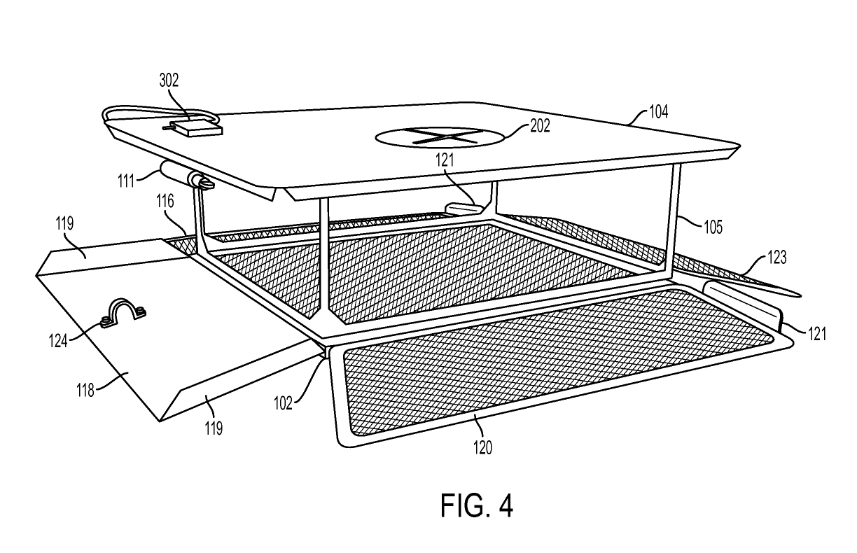

As shown in FIGS. 1A and 1B, the game-release box 100 comprises four sides. In alternative embodiments, the number of sides of the game-release box 100 may be increased or decreased as desired. In yet another embodiment, the fixed wall 114 may be replaced with a fourth door 123 as shown in FIG. 4.

Referring now to FIG. 2, an exploded assembly of the game-release box 100 is shown according to an exemplary embodiment. In the embodiment shown, the frame 105 is a rectangular prism having 4 vertical faces and two horizontal faces. In alternative embodiments, the frame 105 may take on other shapes as desired. The bottom surface 102 is attached to a bottom side of the frame 105. In a typical embodiment, the bottom surface 102 is made out of a thin sheet metal. However, the bottom surface 102 may be made out of various materials, such as wood or plastic, as desired. Additionally, it may be desirable to make the bottom surface 102 out of a perforated material. The bottom surface 102 may be attached to the frame 105 with various types of removable fasteners, or the bottom surface 102 may be permanently attached to the frame 105 (e.g., welded). In a typical embodiment the bottom surface 102 is secured to the frame 105 with screws.

Each edge of the bottom surface 102 may include one or more hinge pieces 117. Each hinge piece 117 receives a corresponding hinge piece 115 that is located on each of the side door 116, the main door 118, and the side door 120. Hinge pieces 115 and 117, when appropriately connected, for example via a pin, form a hinged connection that secures the side door 116, the main door 118, and the side door 120 to the game-release box 100. The hinged connection also permits the side door 116, the main door 118, and the side door 120 to pivot.

The top surface 104 is attached to a top side of the frame 105. In a typical embodiment the top surface 104 is made out of a thin sheet metal. However, the top surface 104 may be constructed out of plastic, wood, etc. The top surface 104 may be attached to the frame 105 with various types of removable fasteners, or the top surface 104 may be permanently attached to the frame 105 (e.g., welded). In a typical embodiment, the top surface 104 is secured to the frame with screws. In a typical embodiment, the top surface 104 is larger than the bottom surface 102. This relative size-based relationship permits at least one of the side door 116, the main door 118, and the side door 120 to form an obtuse angle with respect to the bottom surface 102 when each of the side door 116, the main door 118, and the side door 120 are in the closed position. In a typical embodiment, the side door 116, the main door 118, and the side door 120 each form an obtuse angle with respect to the bottom surface 102 when each of the side door 116, the main door 118, and the side door 120 are in the closed position

The top surface 104 includes a loading port 202. The loading port 202 is formed in the top surface 104. A flap 203 is disposed across the loading port 202. In a typical embodiment, the flap 203 is constructed of a flexible material such as, for example, rubber. A plurality of slits 206 are formed in the flap 203. In a typical embodiment, the plurality of slits 206 allows the flap 203 to open responsive to pressure applied to the flap 203. When the pressure is removed from the flap 203, the flap 203 generally returns back to the same closed position it was in before the pressure was applied to the flap 203.

A cover 204 may be used to further secure the loading port 202. In one embodiment, the top surface 104 may be constructed from a ferrous metal. In this embodiment the cover 204 may be a magnetic sheet appropriately sized to cover the loading port 202. In another embodiment, the top surface 104 may be constructed from a non-ferrous material such as, for example, plastic. In this embodiment, the cover 204 may be secured to the top surface 104 using Velcro, a magnetic face, rotatable latches, etc. To enable the use of a magnetic cover 204 with a plastic or other non-ferrous material, a ferrous ring may be secured around the port 202 to facilitate a magnetic coupling of the magnetic cover 204 and the top surface 104.

The side door 116 is adjacent to the fixed wall 114 and the main door 118. The side door 120 is disposed on a side opposite the side door 116. The side door 116, the main door 118, and the side door 120 are hingedly connected to the bottom surface 102 via the hinge pieces 115 and 117 that were discussed previously. The game-release box 100 may be constructed with more or fewer doors as desired. For example, the game-release box 100 could have one, two, three, or four doors. An exemplary embodiment of a game-release box 100 with four doors is shown in FIG. 4. Furthermore, the bottom surface 102 and the top surface 104 can have a triangular, pentagonal, or other shape as desired. In a typical embodiment, a number of vertical faces of the game-release box 100 will correspond to the number of sides that the bottom surface 102 and the top surface 104 have.

In a typical embodiment of the game-release box 100, when in the closed position, the side door 116, the main door 118, and the side door 120 extend from the bottom surface 102 to the top surface 104. A latch 124 is disposed on the main door 118. In a typical embodiment, the latch 124 is an arch or semicircular shape. When the main door 118 is in the closed position, the latch 124 is engaged by a linear actuator 111. The linear actuator 111 can be one of many types of linear actuators so long as the actuator provides enough linear travel to fully engage and disengage the latch 124. In a typical embodiment, the linear actuator 111 engages the latch 124 by extending through the latch 124. To disengage the latch 124, the linear actuator 111 retracts from the latch 124. Engagement of the latch 124 with the linear actuator 111 holds the main door 118 in the closed position. In alternative embodiments, other types of latching mechanisms could be used.

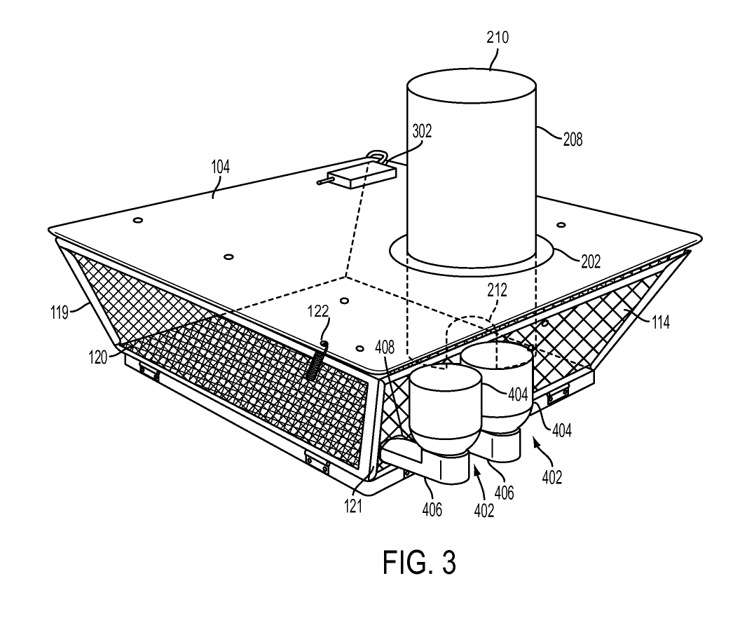

The main door 118 includes a pair of tabs 119 that run along edges of the main door 118. A first tab of the pair of tabs 119 overlaps a portion of the side door 116, and a second tab of the pair of tabs 119 overlaps a portion of the side door 120. When the main door 118 is in the closed position, the side door 116 and the side door 120 are held in a closed position by the pair of tabs 119. For such an arrangement to work, it is necessary that side doors 116 and 120 be manually placed in the closed position prior to closing the main door 118. The tabbed arrangement permits the user to decide how many walls will open when the latch 124 is disengaged. For example, if desired, the user may use one or more restraints 122 to secure the side door 116, the side door 120, or both to the top surface 104 (see FIG. 3). Restraints 122 can made from various materials such as, for example, springs, straps, bungees, etc. When both side doors 116 and 120 are secured via one or more restraints 122, only the main door 118 will open when the linear actuator 111 releases the latch 124. A configuration where only one door opens may be desirable where the type of game stored in the cage will become over-stressed by the movement of all three of the doors 116, 118, and 120. For example, pheasants tend to flush or fly off when all three doors 116, 118, and 120 are simultaneously opened. In such a situation, the user may wish to secure the side door 116 and the side door 120 to reduce the amount of movement presented to the pheasant. With only one door opening, it is more likely that the pheasant will calmly walk out of the game-release box 100 instead of quickly taking flight.

In one embodiment, each of the doors 116, 118, and 120 forms an obtuse angle with respect to the bottom surface 102. The obtuse angle makes it easier for gravity to cause each of the doors 116, 118, and 120 to fall into the open position when they are not otherwise restrained by the linear actuator 111 or by one or more restraints 122. In another embodiment, the side door 116, the main door 118, and the side door 120 are spring biased towards an open position. In such an embodiment, a spring is positioned between a portion of either of the bottom surface 102 or the top surface 104 and the side door 116, the main door 118, and the side door 120. The spring may be attached to a tab associated with either the bottom surface 102 or the top surface 104. In such an embodiment, when the side door 116, the main door 118, and the side door 120 are in the closed position, each of the springs is compressed. Upon releasing the linear actuator 111, the springs urge each of the side door 116, the main door 118, and the side door 120 into the open position.

The fixed wall 114 is disposed on a side opposite the main door 118. In a typical embodiment, the fixed wall 114 is not movable and extends from the bottom surface 102 to the top surface 104. As seen in FIG. 3, the fixed wall 114 may include one or more ports 408. The port 408 allows a water source 402 to provide water to game animals inside the game-release box 100. The water source 402 includes a trough 406 and a water bottle 404. In a typical embodiment, the water bottle 404 is coupled to an exterior of the fixed wall 114. As shown in FIG. 3, the trough 406 extends inwardly through the port 408 to an interior of the game-release box 100. Using a second port 408, a food source or an additional water source 402 could similarly be included. Though not shown in FIG. 3, the water source 402 could be secured within the game-release box 100 to the bottom surface 102 or the top surface 104. Such an arrangement would allow the game-release box 100 to include four doors such that when the four doors are in the open position, the game-release box 100 is open on all sides.

Referring now to FIG. 4, an embodiment of a game release box 100 with four doors is shown. In the embodiment shown in FIG. 4, the fixed wall 114 is replaced with a back door 123. In this embodiment, the side door 116 and the side door 120 each include a tab 121 located on an edge adjacent to the back door 123. When the side door 116 and the side door 120 are in the closed position, each of the tabs 121 overlaps a portion of the back door 123. When the side door 116 and the side door 120 are in the open position, the tabs 121 no longer restrict the back door 123 and the back door 123 may open as long as it is not secured to the top surface 104 by a restraint 122.

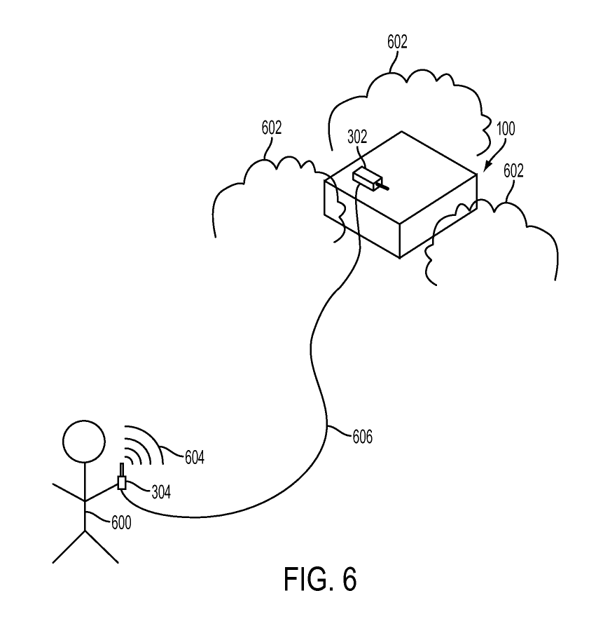

Referring again to FIG. 2, a receiver 302 may be disposed on the top surface 104 of the game-release box 100. The receiver 302 is electrically coupled to the linear actuator 111 via a wire 113. In operation, the receiver 302 receives a wireless signal from a transmitter 304. The transmitter 304 is disposed remotely from the game-release box 100. The receiver 302 and the transmitter 304 may be one of many types of wireless or wired receivers and transmitters. For example, a Pro Control® RL manufactured by Tri-Tronics, Inc. may be used. In a typical embodiment, the transmitter 304 emits a signal that may be received by the receiver 302. For example, the transmitter 304 may emit a wireless radio-frequency signal. In other embodiments, game-release boxes utilizing transmitters having, for example, wired connections may be used (see FIG. 6). Upon receiving a signal from the transmitter 304, the receiver 302 sends a signal to the linear actuator 111 that causes the linear actuator 111 to disengage the latch 124. With the latch 124 no longer engaged by the linear actuator 111, the main door 118 falls open. As the main door 118 falls open, the pair of tabs 119 disengages the side door 116 and the side door 120, each of which will also fall open if not secured to the top surface 102 by one or more restraints 122.

Referring now to FIG. 3, an embodiment of the game-release box 100 with a loading tube 208 inserted into the loading port 202 is shown. The loading tube 208 has an opening 210 formed at a first end of the loading tube 208 and a doorway opening 212 formed in a second end of the loading tube 208. In a typical embodiment, inserting the loading tube 208 into the loading port 202 displaces the flap 203. Insertion of the loading tube 208 into the loading port 202 facilitates placement of small-game animals, such as, for example, birds, into the game-release box 100. In other embodiments, the game-release box 100 and its components can be scaled up or down as desired depending on the size of the game animal being used. A small-game animal is inserted into the opening 210. After so inserted, the small-game animal my exit the loading tube 208 though the doorway opening 212 and enter the game-release box 100. After the small-game animals have been inserted into the game-release box 100, the loading tube 208 is removed. As the loading tube 208 exits the loading port 202, the flap 203 reforms to close the loading port 202 to prevent an escape of the small-game animals that were just loaded. If desired, the cover 204 may then be placed over the loading port 202 to further secure the small-game animals in the game-release box 100. In an alternative embodiment, one or more game animals may be loaded in to the game-release box 100 without the loading tube 208.

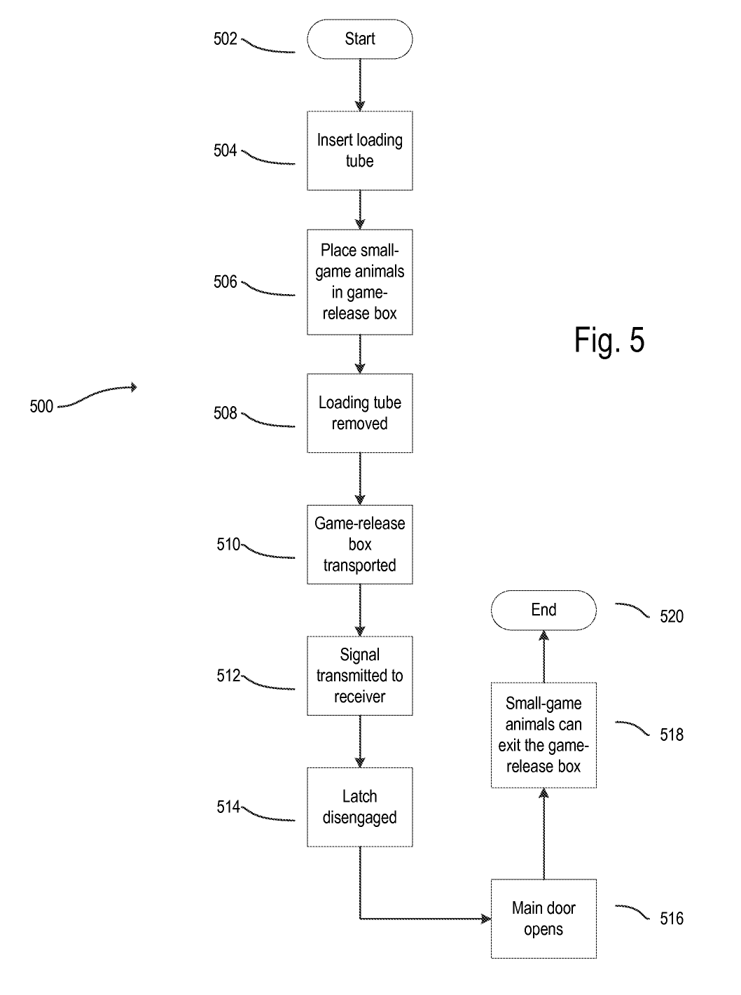

FIG. 5 is a flow diagram of a process 500 for using the game-release box 100. The process 500 begins at step 502 where the game-release box 100 is in a closed position with each of the doors 116, 118, and 120 closed. At step 504, the loading tube 208 is inserted into the loading port 202. At step 506, small-game animals such as, for example, birds are placed in the game-release box 100 via the loading tube 208. At step 508, the loading tube 208 is removed. If desired, the cover 204 may also be placed over the loading port 202 to secure the loading port 202. At step 510, the game-release box 100 is transported to a location for hunting game. At step 512, the transmitter 304 sends a signal to the receiver 302. At step 514, the receiver 302 directs the linear actuator 111 to release the latch 124. At step 516, the main door 118 opens, which in turn frees the side door 116 and the side door 120 to open unless otherwise secured to the top surface 104 by one or more restraints 122. At step 518, the small-game animals such as, for example, birds may exit the game-release box 100, facilitating hunting of the small-game animals. The process 500 ends at step 520.

In one embodiment, step 512 is performed by a hunting guide. When the hunting guide has determined that the small-game animals should be released, he or she may operate the transmitter 304 by, for example, pressing a button to cause the transmitter 304 to communicate with the receiver 302 to activate the linear actuator 111. In another embodiment, step 512 is performed automatically when the transmitter 304 is within a predetermined range of the receiver 302. Automatically initiating release of the release the latch 124 may be desirable as it more closely simulates a hunt where the wild game is spooked or flushed out by the presence of a guide, hunter, or dog. For example, if desired, a receiver can recognize when a transmitter is within a predetermined range. When this condition is met, the receiver automatically sends a signal to the linear actuator 111 to release the latch 124. In this embodiment the transmitter may be carried by a hunting guide, by a hunting dog (by attaching the transmitter to the dog's collar or otherwise), or by another person participating in the hunting activity.

In alternative embodiments, step 510 may be performed before step 504, or before step 506, or before step 508. In another embodiment, at step 502, the user may secure one or both of the side doors 116 and 120 with a restraint 122 as shown in FIG. 3 to cause fewer than all the doors to open. In another embodiment, steps 504 and 508 can be omitted. Small-game animals may be loaded into the game-release box 100 without using the loading tube 208.

Referring now to FIG. 6, an exemplary use of the game-release box 100 is shown according to an exemplary embodiment. A user 600 is shown at a distance away from the game-release box 100. In a typical embodiment, the game-release box 100 is surrounded by brush 602, or hidden among some of the natural terrain of a hunting area. When the user 600 desires, the user 600 uses the transmitter 304 to send a signal to the receiver 302. According to a first embodiment, the signal is a wireless signal 604. In an alternative embodiment, the signal may be communicated via a wire 606 that is connected between the receiver 302 and the transmitter 304.

Although various embodiments of the method and system of the present invention have been illustrated in the accompanying Drawings and described in the foregoing Specification, it will be understood that the invention is not limited to the embodiments disclosed, but is capable of numerous rearrangements, modifications, and substitutions without departing from the spirit and scope of the invention as set forth herein. It is intended that the Specification and examples be considered as illustrative only.

What is claimed is:

1. A game-release box comprising:
a frame including at least four sides, the four sides defining a space within the frame;
a first door pivotally attached to a first bottom edge of one of the at least four sides of the frame, the first door including a latch;
an actuator attached to the frame and positioned to selectively engage the latch;
a receiver attached to the game-release box, the receiver operatively coupled to the actuator;
wherein the actuator disengages from the latch in response to a signal sent to the receiver from a remote; and
wherein the first door opens after the actuator disengages the latch.

2. The game-release box of claim 1 further comprising:
a first tab disposed on a first edge of the first door and a second tab disposed on a second edge of the first door;
a second door adjacent to the first door and pivotally attached to a second bottom edge adjacent to the first bottom edge; and
wherein the first tab overlaps a portion of the second door, thereby securing the second door in a closed position when the first door is in a closed position.

3. The game-release box of claim 2 further comprising:
a third door adjacent to the first door and pivotally attached to a third bottom edge adjacent to the first bottom edge; and
wherein the second tab overlaps a portion of the third door, thereby securing the third door in a closed position when the first door is in a closed position.

4. The game-release box of claim 1 further comprising:
a top surface attached to a top portion of the frame;
a loading port formed through the top surface, the loading port adapted to receive one or more game animals into the game-release box; and
a cover adapted to cover the loading port to selectively secure the one or more game animals within the game-release box.

5. The game-release box of claim 4 further comprising:
a flap made of a semi-rigid material that spans an opening of the loading port, the flap having one or more slits that permit the one or more game animals to pass through the flap.

6. The game-release box of claim 1 further comprising:
a fixed walled attached to the frame; and
at least one of a food source and a water source that is attached to the fixed wall.

7. The game-release box of claim 1 wherein the first door, when in a closed position, makes an obtuse angle relative to a bottom of the game-release box.

8. The game-release box of claim 4 further comprising:
a loading tube including a first opening and a second opening, the second opening including a doorway opening; and
wherein the loading tube may be inserted into the loading port to facilitate loading of one or more game animals into the game-release box.

9. The game-release box of claim 2 wherein the second door, when in a closed position, makes an obtuse angle relative to a bottom of the game-release box.

10. The game-release box of claim 2 further comprising:
a restraint having a first end and a second end, the first end of the restraint is attached to the second door and the second end of the restraint is attached to a top surface; and
wherein the restraint prevents the second door from opening when the first door is open.

11. A method of remotely controlling a release of one or more game animals, the method comprising:
inserting one or more game animals into a game-release box;
placing the game-release box in a selected area;
sending a signal from a remote to a receiver; and
responsive to receiving the signal, opening a door of the game-release.

12. The method of claim 11 wherein the step of inserting includes first inserting a loading tube comprising a first opening and a second opening, the second opening including a doorway opening.

13. A game-release box comprising:
a bottom surface;
a first door attached to a first edge of the bottom surface, the first door including a first tab on a first edge of the first door;
a second door adjacent to the first door and attached to a second edge of the bottom surface;
wherein the first tab overlaps a portion of the second door when the first door and the second door are in the closed position; and
wherein opening the first door allows the second door to open.

14. The game-release box of claim 13 further comprising:
a top surface;
a loading port formed through the top surface, the loading port adapted to receive one or more game animals into the game-release box; and
a cover adapted to cover the loading port to secure the one or more game animals within the game-release box.

15. The game-release box of claim 14 further comprising:
a flap made of a semi-rigid material that spans an opening of the loading port, the flap having one or more slits that permit the one or more game animals to pass through the flap.

16. The game-release box of claim 13 further comprising:
a fixed walled attached to the frame; and
at least one of a food source and a water source that is attached to the game-release box.

17. The game-release box of claim 13 wherein the first door, when in a closed position, makes an obtuse angle relative to a bottom of the game-release box.

18. The game-release box of claim 14 further comprising:
a loading tube including a first opening and a second opening, the second opening including a doorway opening; and
wherein the loading tube may be inserted into the loading port to facilitate loading of one or more game animals into the game-release box.

19. The game-release box of claim 13 wherein the second door, when in a closed position, make an obtuse angle relative to a bottom of the game-release box.

20. The game-release box of claim 13 further comprising:
a restraint having a first end and a second end, the first end of the restraint is attached to the second door and the second end of the restraint is attached to a top surface; and
wherein the restraint prevents the second door from opening when the first door is open.
